(19) United States
(12) Patent Application Publication
(10) Pub. No.: US 2023/0256433 A1
(43) Pub. Date: Aug. 17, 2023

(54) INTERFACE AND CHANNEL DEVICE

(71) Applicant: Enplas Corporation, Saitama (JP)

(72) Inventor: Koichi ONO, Saitama (JP)

(73) Assignee: Enplas Corporation, Saitama (JP)

(21) Appl. No.: 18/102,839

(22) Filed: Jan. 30, 2023

(30) Foreign Application Priority Data
Feb. 17, 2022 (JP) 2022-023062

(51) Int. Cl. B01L 3/00

(52) U.S. Cl. CPC B01L 3/502715; B01L 2200/027; B01L 2300/0861

(57) ABSTRACT

An interface configured to be brought into contact with a channel chip and to connect a channel of the channel chip with an external device. The interface includes an elastic first member and a second member supporting the first member. The first member includes a first channel for communicating with the channel and a second channel for communicating with the external device. The first channel and the second channel communicate with each other, and the second channel is disposed in such a way that a distance from the center of gravity of the channel chip to the second channel increases from the end of the second channel on the first channel side toward the end of the second channel on the external device side when the interface is viewed in plan view while the interface is in contact with the channel chip.

### CROSS REFERENCE TO RELATED APPLICATIONS

This application claims the benefit of priority of Japanese Patent Application No. 2022-023062, filed on Feb. 17, 2022, the disclosure of which including the specification, drawings and abstract is incorporated herein by reference in its entirety.

### TECHNICAL FIELD

The present invention relates to an interface configured to be brought into contact with a channel chip and to connect a channel of the channel chip with an external device, and relates to a channel device including the interface.

### BACKGROUND ART

In recent years, channel chips have been used to analyze trace amounts of substances such as proteins and nucleic acids with high accuracy and high speed. Channel chips have the advantage of requiring only a small amount of reagents and samples for analysis, and are expected to be used in a variety of applications such as clinical tests, food tests, and environment tests. As described in Patent Literature (hereinafter, referred to as PTL) 1, a channel chip is typically connected with an external device (for example, a tube or a pump) for moving a fluid in the channel chip.

### CITATION LIST

### Patent Literature

### PTL 1

Japanese Patent Application Laid-Open No. 2017-166989

### SUMMARY OF INVENTION

### Technical Problem

As illustrated in FIG. 1, microchannel chip 2 including microchannel 1 as described in PTL 1 is connected to external device (i.e., tube) 13 from the surface side of microchannel chip 2, and thus tube 13 protrudes from the surface. Protrusion of tube 13 in this manner causes difficulty in handling microchannel chip 2. For example, for observing microchannel 1 of microchannel chip 2 with an optical microscope or the like from the surface side of microchannel chip 2, the observation may become difficult due to interference between tube 13 and the optical microscope.

An object of the present invention is to provide an interface for connecting a channel of a channel chip with an external device, and capable of preventing the protrusion of the external device from the surface of the channel chip.

### Solution to Problem

An interface of the present invention is configured to be brought into contact with a channel chip and to connect a channel of the channel chip with an external device. The interface includes: a first member that is elastic; and a second member supporting the first member, in which

the first member includes a first channel for communicating with the channel and a second channel for communicating with the external device, in which the first channel and the second channel communicate with each other, and the second channel is disposed in such a way that a distance from a center of gravity of the channel chip to the second channel increases from an end of the second channel on a side of the first channel toward an end of the second channel on a side of the external device when the interface is viewed in plan view while the interface is in contact with the channel chip.

A channel device of the present invention includes: a channel; and an interface for connecting the channel with an external device, in which
the interface includes a first member that is elastic, and a second member supporting the first member, in which
the first member includes a first channel for communicating with the channel and a second channel for communicating with the external device, in which
the first channel and the second channel communicate with each other, an angle between central axes of the first channel and the second channel is less than 180°, and the second channel is disposed in such a way that a distance from a center of gravity of the channel device to the second channel increases from an end of the second channel on a side of the first channel toward an end of the second channel on a side of the external device when the interface is viewed in plan view while the interface is connected with the channel.

### Advantageous Effects of Invention

The present invention can provide an interface for connecting a channel of a channel chip with an external device, and capable of preventing the protrusion of the external device from the surface of the channel chip.

### BRIEF DESCRIPTION OF DRAWINGS

FIG. 1 illustrates a microchannel chip of PTL 1;

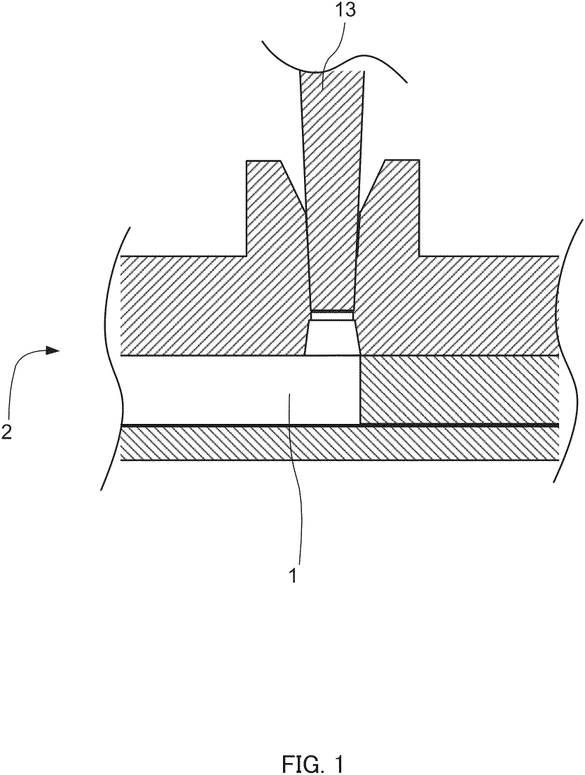

FIG. 2A is a perspective view of an interface and FIG. 2B is a cross-sectional perspective view of the interface;

FIGS. 3A, 3B, and 3C are cross-sectional views of an interface according to Embodiment 1;

FIG. 4A is a cross-sectional view of an interface according to Embodiment 2, and FIG. 4B is a cross-sectional view of an interface according to Embodiment 3; and

FIG. 5A is a cross-sectional view of an interface according to Embodiment 4, and FIG. 5B is a cross-sectional view of an interface according to Embodiment 5.

### DESCRIPTION OF EMBODIMENTS

### Interface and Channel Device of Present Invention

An interface of the present invention can be used to connect channel 21 in channel chip 20 with an external device, and to move a fluid in the channel. Herein, an external device means a device such as a pump, or an instrument such as a container or tube. An interface of the present invention may be a part of channel chip 20 or may be a component separate from channel chip 20 and brought into contact with channel chip 20 for use.

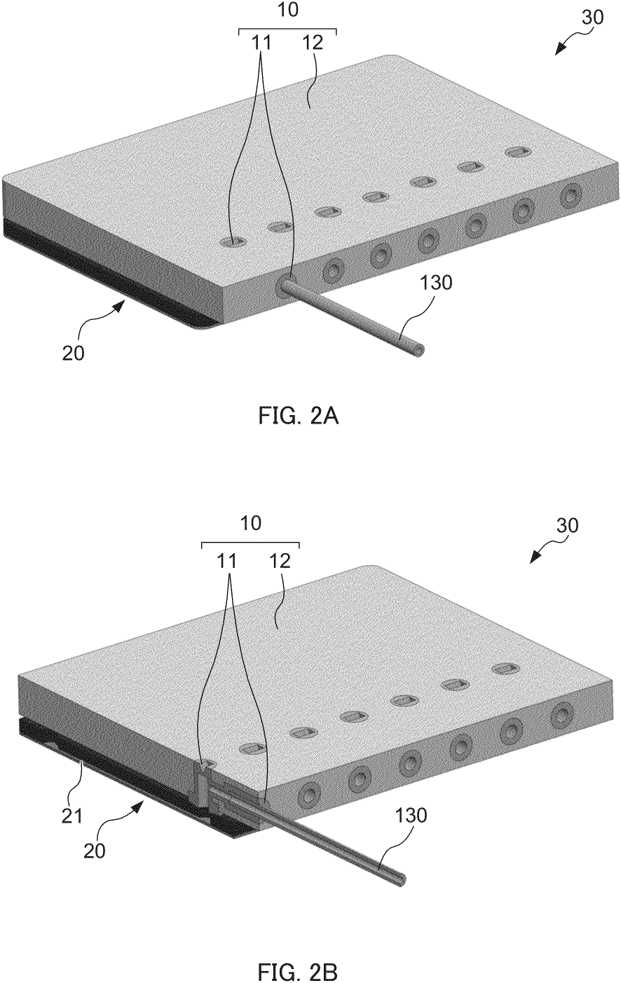

FIGS. 2A and 2B are perspective views illustrating exemplary channel device 30 that includes channel chip 20 and interface 10 to be used in combination with channel chip 20. FIG. 2B also illustrates a cross section of interface 10 and channel chip 20. Interface 10 includes first members 11 and second member 12. First member 11 is connected with an external device (for example, tube) 130. In this example, tube 130 is connected to a power source such as a pump or a syringe. Through external device 130 and interface 10, negative and positive pressure can be applied to a fluid (for example, gas or liquid) in channel 21 of channel chip 20 to move the fluid.

Hereinafter, interfaces according to Embodiments 1 to 5 will be described. Each interface according to Embodiments 1 to 4 is a component separate from channel chip 20 and brought into contact with channel chip 20 for use, and the interface according to Embodiment 5 is a part of channel chip 20.

### Embodiment 1

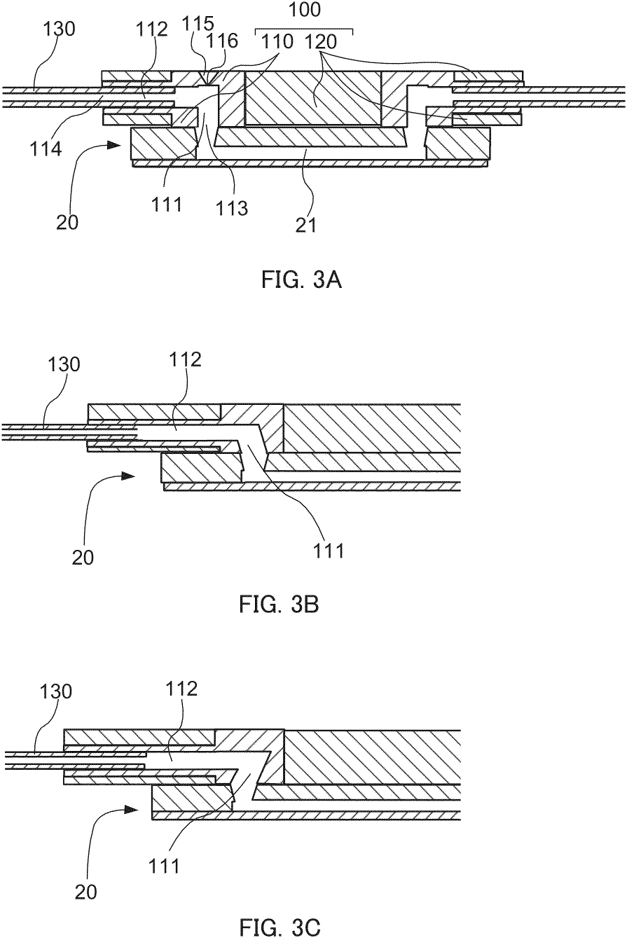

FIG. 3A is cross-sectional view of interface 100 according to Embodiment 1.

Interface 100 includes first member 110 and second member 120, and second member 120 supports first member 110. In the present embodiment, first member 110 and second member 120 are preferably formed by two-color molding or insert molding.

In a process of forming first member 110 and second member 120 by insert molding, first member 110 is an insert, and the material to be molded into second member 120 fills a mold around first member 110 inserted into the mold. Such a process allows second member 120 to support first member 110. In addition, in the present embodiment, the interface includes a flat surface, to which at least one of external pressure and heat is to be applied, in the surface opposite to the surface in contact with channel chip 20, as illustrated in FIG. 3A. Specifically, first member 110 and second member 120 form one surface extending substantially parallel to the bottom surface of channel chip 20 on the front surface side of interface 100.

First member 110 connects channel 21 of channel chip 20 with external device 130. First member 110 also functions as a gasket, thus is elastic. Examples of the material of first member 110 include elastomers and resins. The number and positions of first members 110 are not limited, and are appropriately set according to, for example, the number and positions of the opening(s) of channel(s) 21 of channel chip 20.

As illustrated in FIG. 3A, first member 110 includes first channel 111 and second channel 112, and first channel 111 and second channel 112 communicate with each other. Second channel 112 is disposed in such a way that the distance from the center of gravity of channel chip 20 to second channel 112 increases from the end of the second channel on the first channel 111 side toward the end of the second channel on the external device 130 side when interface 100 is viewed in plan view while interface 100 is in contact with channel chip 20. Disposition such that external device (for example, tube) 130 connected to second channel 112 protrudes from the surface of channel chip 20 can be prevented by such a configuration.

Specifically, the angle between the central axes of first channel 111 and second channel 112 is preferably less than 180°. As illustrated in FIG. 3A, first channel 111 is disposed along a direction substantially perpendicular to the bottom surface of channel chip 20, and second channel 112 is disposed along a direction substantially parallel to the bottom surface of channel chip 20 in the present embodiment. In such a configuration, the angle between the central axes of first channel 111 and second channel 112 is approximately 90°.

FIG. 3B illustrates an example in which the angle between the central axes of first channel 111 and second channel 112 is less than 180° and more than 90°. FIG. 3C illustrates an example in which the angle between the central axes of first channel 111 and second channel 112 is less than 90°.

When the angle between the central axes of first channel 111 and second channel 112 is not approximately 90° (the central axis of first channel 111 is inclined with respect to the bottom surface of the interface), as illustrated in FIGS. 3B and 3C, the thickness of interface 100 can be reduced, thereby easily transferring heat from the outside to the channel chip.

When the angle between the central axes of first channel 111 and second channel 112 is less than 90°, the lower limit of the angle is not limited, but the angle is, for example, preferably 30° or more, more preferably 45° or more.

The interface includes at least one channel including first channel 111 and second channel 112 that satisfy the above requirements. For example, when interface 100 includes two channels communicating with channel 21 of channel chip 20—one of the two channels is on the inlet side and the other one of the two channels is on the outlet side, at least one of the inlet side channel and the outlet side channel includes a first channel and a second channel that satisfy the above requirements.

First channel 111 opens to first opening 113 for communicating with the channel of channel chip 20. First opening 113 is surrounded by first member 110, which is elastic, and first member 110 directly contacts channel chip 20. This configuration prevents the formation of a gap between first member 110 and the opening of channel chip 20, thus prevents the leakage of a fluid (for example, gas or liquid) passing through channel 21 to the outside. Therefore, use of a sealing member, such as packing or a gasket, between channel chip 20 and interface 100 is not necessary according to interface 100 of the present embodiment.

From the viewpoint of bringing first member 110 into close contact with channel chip 20 to prevent fluid leakage as described above, first member 110 around first opening 113 preferably protrudes from the back surface of interface 100, as illustrated in FIG. 3A.

Second channel 112 opens to second opening 114, and second opening 114 communicates with an external device (such as a tube) 130. Second channel 112 is preferably configured to be connectable to external device 130. In the present embodiment, an external device (tube 130) is inserted into second channel 112, as illustrated in FIG. 3A.

First member 110 may include needle insertion part 115, as illustrated in FIG. 3A. Needle insertion part 115 is a part for inserting a hollow needle from the outside of the interface to first channel 111 or to second channel 112. For example, a syringe is connected to the hollow needle, and operating the syringe can move a fluid into and out of channel 21 of channel chip 20.

Needle insertion part 115 preferably includes slit 116 that is openable and closable according to the position of the hollow needle. Specifically, the needle insertion part is preferably configured in such a way that slit 116 is opened when the hollow needle is inserted into slit 116 and is closed when the hollow needle is not placed in the slit. In the present embodiment, needle insertion part 115 is a V-shaped recess, and slit 116 is formed at the bottom (valley portion) of the recess.

It is possible not to provide needle insertion part 115 in first member 110. Even when first member 110 does not include needle insertion part 115, as first member 110 is elastic, the hollow needle can be inserted to move a fluid into and out of a channel.

Second member 120 supports first member 110 and improves handling of interface 100. Second member 120 may have any configuration as long as the second member can support first member 110. In the present embodiment, second member 120 is a plate-shaped member configured to surround first member 110 forming first channel 111 and second channel 112.

Second member 120 preferably is less elastic than first member 110 from the viewpoint of properly supporting first member 110. Examples of the material of second member 120 include elastomers and resins. For observing channel 21 of channel chip 20 through second member 120 with an optical microscope or the like, second member 120 preferably has a shape (for example, of a flat plate) so as not to interfere with observation of channel 21, and is preferably made of a material transparent to visible light.

### Effect

Interface 100 is configured to be connected to external device 130 from the side surface, not from the upper surface, of interface 100. External device 130 thus does not protrude above channel chip 20. Therefore, it is possible to dispose an optical microscope, a heating device, or the like close to the space above channel chip 20, or to apply pressure to channel chip 20 from above and below, thereby expanding the use of channel chip 20.

### Embodiment 2

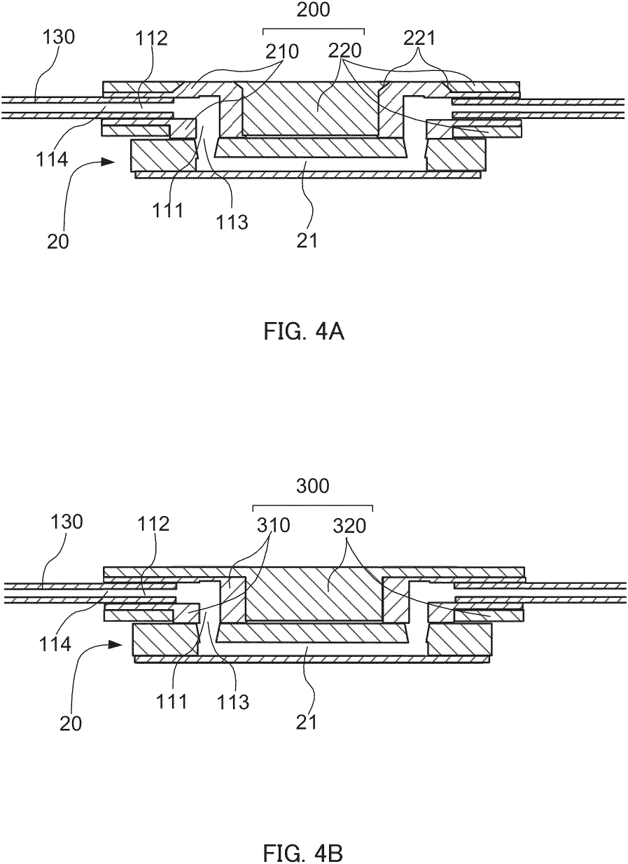

FIG. 4A is a cross-sectional view of interface 200 according to Embodiment 2. In interface 200, the same components as those of interface 100 are denoted by the same reference numerals, and the description thereof is omitted.

Interface 200 differs from interface 100 in that second member 220 includes support 221. Support 221 is a member for preventing the movement of first member 210 when first member 210 is pressed from the side (lower side) where the channel of channel chip 20 is located. Support 221 helps first member 210 to close the hole when a hollow needle is inserted into and then removed from the first member.

In the present embodiment, support 221 is a tapered surface whose inner diameter decreases as the distance from first opening 113 to the tapered surface increases.

### Effect

In interface 200, second member 220 includes support 221; thus second member 220 can support first member 210 more easily. In addition, when a hollow needle is inserted into and then removed from first member 210, the hole can be closed more easily.

### Embodiment 3

FIG. 4B is a cross-sectional view of interface 300 according to Embodiment 3. In interface 300, the same components as those of interface 100 are denoted by the same reference numerals, and the description thereof is omitted.

Interface 300 differs from interfaces 100 and 200 in that first member 310 is covered with second member 320 on the front side (upper side) of interface 300 and thus first member 310 is not exposed to the outside.

As described above, in interface 300, first member 310 is covered with second member 320. This configuration can more reliably prevent first member 310 from moving when first member 310 is pressed from the side where the channel of channel chip 20 is located. In this way, second member 320 covering first member 310 functions as a support for preventing the movement of first member 310.

### Effect

In interface 300, first member 310 is covered with second member 320 on the front side of the interface. Therefore, second member 320 can support first member 310 more easily.

### Embodiment 4

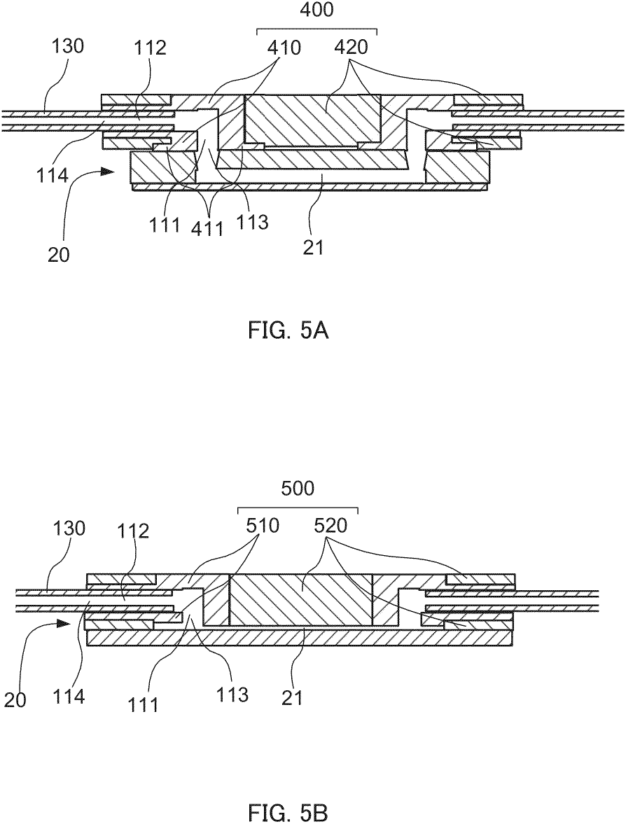

FIG. 5A is cross-sectional view of interface 400 according to Embodiment 4. In interface 400, the same components as those of interface 100 are denoted by the same reference numerals, and the description thereof is omitted.

Interface 400 differs from interfaces 100, 200, and 300 in that first member 410 includes flange 411 around first opening 113. The upper surface of flange 411 serves as a step surface of first member 410, and second member 420 includes a step surface that engages with the step surface of first member 210 as a support. As illustrated in FIG. 5A, the step surface of first member 210 (the upper surface of flange 411) is disposed closer to the side (lower side), where the channel of channel chip 20 is located, than the step surface of second member 420 is. This configuration prevents the movement of first member 410 when first member 410 is pressed from the side (lower side), where the channel of channel chip 20 is located.

The presence of flange 411 in interface 400 increases the area of a contact surface around the opening of channel chip 20. This configuration prevents the formation of a gap between first member 410 and the periphery of the opening of channel chip 20 and more reliably prevents the leakage of a fluid (for example, gas or liquid) to the outside.

Flange 411 may have any configuration as long as the flange is disposed around first opening 113 and can increase the area of the contact surface with the channel chip 20. In the present embodiment, flange 411 has a shape extending around first opening 113 in a direction parallel to the front surface of channel chip 20. In addition, in the present embodiment, flange 411 is configured to protrude from the back surface of interface 400.

### Effect

With interface 400, second member 420 can support first member 410 more easily, and fluid leakage to the outside can be more reliably prevented.

### Embodiment 5

FIG. 5B is cross-sectional view of interface 500 according to Embodiment 5. In interface 500, the same components as those of interface 100 are denoted by the same reference numerals, and the description thereof is omitted.

Interface 500 is different from interfaces according to other embodiments in that interface 500 is a part of channel chip 20. In other words, FIG. 5B illustrates a channel device including a channel and an interface. Specifically, first member 510 and second member 520 form a part of the upper portion of the channel wall of channel 21 in interface 500, as illustrated in FIG. 5B. In addition, in interface 500, first opening 113 directly communicates with channel 21.

Interface 500 is a part of channel chip 20 as described above; thus there is no gap between first member 510 of interface 500 and channel chip 20. Therefore, fluid leakage to the outside can be more reliably prevented.

### Effect

Interface 500 can more reliably prevent fluid leakage to the outside.

### INDUSTRIAL APPLICABILITY

Interfaces of the present invention are particularly advantageous for channel chips used in a variety of applications such as clinical tests, food tests, and environment tests.

REFERENCE SIGNS LIST

| | |
|---|---|
| 1 | Microchannel |
| 2 | Microchannel chip |
| 10, 100, 200, 300, 400, 500 | Interface |
| 11, 110, 210, 310, 410, 510 | First member |
| 12, 120, 220, 320, 420, 520 | Second member |
| 13, 130 | External device (tube) |
| 20 | Channel chip |
| 21 | Channel |
| 30 | Channel device |
| 111 | First channel |
| 112 | Second channel |
| 113 | First opening |
| 114 | Second opening |
| 115 | Needle insertion part |
| 116 | Slit |
| 221 | Support |
| 411 | Flange |

1. An interface configured to be brought into contact with a channel chip and to connect a channel of the channel chip with an external device, the interface comprising:
a first member that is elastic; and
a second member supporting the first member, wherein
the first member includes a first channel for communicating with the channel, and a second channel for communicating with the external device, wherein
the first channel and the second channel communicate with each other, and
the second channel is disposed in such a way that a distance from a center of gravity of the channel chip to the second channel increases from an end of the second channel on a side of the first channel toward an end of the second channel on a side of the external device when the interface is viewed in plan view while the interface is in contact with the channel chip.

2. The interface according to claim 1, wherein an angle between central axes of the first channel and the second channel is less than 180°.

3. The interface according to claim 1, wherein an angle between central axes of the first channel and the second channel is 90° or less.

4. The interface according to claim 1, further comprising a flat surface in a surface opposite to a surface to be brought into contact with the channel chip, the flat surface being a flat surface to which at least one of external pressure and/or heat is to be applied.

5. The interface according to claim 1, wherein the second member is less elastic than the first member.

6. The interface according to claim 1, wherein the first member and the second member are formed by two-color molding or insert molding.

7. The interface according to claim 1, wherein the second member includes a support for preventing the first member from moving when the first member is pressed from a side where the channel of the channel chip is located.

8. The interface according to claim 7, wherein:
the support is a step surface of the second member, the step surface engaging with a step surface of the first member; and
the step surface of the first member is disposed closer to the side, where the channel of the channel chip is located, than the step surface of the second member is.

9. The interface according to claim 7, wherein the support is a tapered surface whose inner diameter decreases as a distance from the channel of the channel chip to the tapered surface increases.

10. The interface according to claim 1, wherein the first member includes a needle insertion part for inserting a hollow needle from an outside of the interface to the first channel or to the second channel.

11. The interface according to claim 10, wherein the needle insertion part includes a slit that is openable and closable according to a position of the hollow needle.

12. A channel device, comprising:
a channel; and
an interface for connecting the channel with an external device, wherein
the interface includes
a first member that is elastic, and
a second member supporting the first member, wherein
the first member includes a first channel for communicating with the channel, and a second channel for communicating with the external device, wherein
the first channel and the second channel communicate with each other,
an angle between central axes of the first channel and the second channel is less than 180°, and
the second channel is disposed in such a way that a distance from a center of gravity of the channel device to the second channel increases from an end of the second channel on a side of the first channel toward an end of the second channel on a side of the external device when the interface is viewed in plan view while the interface is connected with the channel.
